(19) United States
(12) Patent Application Publication
(10) Pub. No.: US 2004/0044551 A1
(43) Pub. Date: Mar. 4, 2004

(54) System and process for facilitating consistent calculation and attribution of costs savings

(75) Inventors: Daniel D. Keefe, Chesterfield, VA (US); Shari L. Marakowitz, Mechanicsville, VA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: GE Financial Assurance Holdings, Inc.

(21) Appl. No.: 10/230,094

(22) Filed: Aug. 29, 2002

(51) Int. Cl. G06F 17/60

(52) U.S. Cl. 705/7

(57) ABSTRACT

The present invention relates to a system and process for facilitating consistent calculation and attribution of cost savings within an organization. More specifically, the present invention relates to a system and process for guiding a user through a series of determinations related to various cost savings for attributing the cost savings to specific classifications and calculating the cost savings.

### BACKGROUND OF THE INVENTION

The present invention relates to a system and process for facilitating consistent calculation and attribution of cost savings. More specifically, the present invention relates to a system and process for guiding a user through a series of determinations related to various cost savings for attributing the cost savings to specific classifications and calculating the cost savings.

Most organizations, whatever their primary focus, are interested in cost savings. It is common for organizations to embark on various cost savings incentives to improve profits, reduce losses and/or improve efficiency. The initiatives may be of varying scope and size.

One problem with cost savings initiatives may be properly classifying and attributing the savings. It may be beneficial to an organization to determine the reason for given cost savings. However, many factors may contribute to particular cost savings. The interactive nature of these factors may prevent consistent attribution of the cost savings to the proper classes.

Further, many organizations lack a procedure to appropriately calculate the cost savings. Errors in math as well as incorrect assumptions or selections of variables (e.g., baseline costs, etc.) may lead to inconsistent or incorrect calculations.

In addition, consistent attribution and calculation of cost savings may be difficult if more than one person is involved in making these determinations. For example, in a corporation with two separate divisions, a person performing calculation in one division may make different determinations than a person in another division, thereby resulting in inconsistent determinations.

Other drawbacks may also exist.

### SUMMARY OF THE INVENTION

An aspect of the present invention is to provide a system and process for consistent and standardized calculations of cost savings.

Further aspects of the invention may eliminate or minimize site-to-site, person-to-person, business-to-business and year-to-year variations and bias.

In an exemplary embodiment of the invention, a process for calculating and attributing cost savings within an organization is provided comprising the steps of determining whether a least a portion of the cost savings is attributable to a plant and equipment purchase, calculating an amount of the plant and equipment cost savings, determining whether a least a portion of the cost savings is attributable to an acquisition, and calculating an amount of the cost acquisition savings. Further steps may include determining whether at least a portion of the cost savings is attributable to outsourcing or insourcing of a specified process, calculating an amount of the outsourcing or insourcing cost savings, determining whether a least a portion of the cost savings is attributable to a disposition, calculating an amount of the disposition cost savings; determining whether at least a portion of the cost savings is attributable to a usage substitution, calculating an amount of the usage substitution cost savings, determining whether at least a portion of the cost savings is attributable to a price or a leakage, and calculating an amount of the price or leakage cost savings. Additional steps may comprise determining whether at least a portion of the cost savings is attributable to a one time event, calculating an amount of the one-time event cost savings, and calculate the cost savings based upon the plant and equipment cost savings, the acquisition cost savings, the outsourcing or insourcing cost savings, the disposition cost savings, the usage substitution cost savings, the price or leakage cost savings, and the one-time expense cost savings.

By way of another exemplary embodiment of the invention, a process calculating and attributing cost reductions using a decision matrix to facilitate consistent attribution may comprise the steps of performing a plurality of determinations for attributing at least a portion of the cost reduction to at least one class, calculating the class cost savings for each class to which a portion of the cost reduction has been attributed, and calculating the total cost savings based on each of the class cost savings.

A further embodiment of the invention provides a medium storing code for causing a processor to calculate and attribute cost savings within an organization comprising code for determining whether a least a portion of the cost savings is attributable to a plant and equipment purchase, code for calculating an amount of the plant and equipment cost savings, code for determining whether a least a portion of the cost savings is attributable to an acquisition, code for calculating an amount of the cost acquisition savings, code for determining whether a least a portion of the cost savings is attributable to outsourcing or insourcing of a specified process, and code for calculating an amount of the outsourcing or insourcing cost savings. The embodiment of the invention further provides code for determining whether a least a portion of the cost savings is attributable to a disposition, code for calculating an amount of the disposition cost savings, code for determining whether a least a portion of the cost savings is attributable to a usage substitution, code for calculating an amount of the usage substitution cost savings, code for determining whether a least a portion of the cost savings is attributable to a price or a leakage, code for calculating an amount of the price or leakage cost savings, code for determining whether at least a portion of the cost savings is attributable to a one time event, code for calculating an amount of the one-time event cost savings, and code for calculate the cost savings based upon the plant and equipment cost savings, the acquisition cost savings, the outsourcing or insourcing cost savings, the disposition cost savings, the usage substitution cost savings, the price or leakage cost savings, and the one-time expense cost savings.

An additional embodiment of the invention may provide a medium storing code for causing a processor to calculate and attribute cost reductions using a decision matrix to facilitate consistent attribution, where the medium comprises code for performing a plurality of determinations for attributing at least a portion of the cost reduction to at least one class, code for calculating the class cost savings for each class to which a portion of the cost reduction has been attributed and code for calculating the total cost savings based on each of the class cost savings.

A further exemplary embodiment of the invention provides a system for calculating and attributing cost savings within an organization comprising of means for determining whether a least a portion of the cost savings is attributable to a plant and equipment purchase, means for calculating an amount of the plant and equipment cost savings, means for determining whether a least a portion of the cost savings is attributable to an acquisition, means for calculating an amount of the cost acquisition savings, means for determining whether a least a portion of the cost savings is attributable to outsourcing or insourcing of a specified process, and means for calculating an amount of the outsourcing or insourcing cost savings. The system further comprises means for determining whether a least a portion of the cost savings is attributable to a disposition, means for calculating an amount of the disposition cost savings, means for determining whether a least a portion of the cost savings is attributable to a usage substitution, means for calculating an amount of the usage substitution cost savings, means for determining whether a least a portion of the cost savings is attributable to a price or a leakage, means for calculating an amount of the price or leakage cost savings, means for determining whether at least a portion of the cost savings is attributable to a one time event, means for calculating an amount of the one-time event cost savings, and means for calculate the cost savings based upon the plant and equipment cost savings, the acquisition cost savings, the outsourcing or insourcing cost savings, the disposition cost savings, the usage substitution cost savings, the price or leakage cost savings, and the one-time expense cost savings.

By way of another exemplary embodiment of the invention, a system for calculating and attributing cost reductions using a decision matrix to facilitate consistent attribution comprises means for performing a plurality of determinations for attributing at least a portion of the cost reduction to at least one class, means for calculating the class cost savings for each class to which a portion of the cost reduction has been attributed, and means for calculating the total cost savings based on each of the class cost savings.

According to another exemplary aspect of the invention, a system for calculating and attributing cost savings within an organization provides a module for determining whether a least a portion of the cost savings is attributable to a plant and equipment purchase, a module for calculating an amount of the plant and equipment cost savings, a module for determining whether a least a portion of the cost savings is attributable to an acquisition, a module for calculating an amount of the cost acquisition savings, a module for determining whether a least a portion of the cost savings is attributable to outsourcing or insourcing of a specified process, a module for calculating an amount of the outsourcing or insourcing cost savings, a module for determining whether a least a portion of the cost savings is attributable to a disposition and a module for calculating an amount of the disposition cost savings. The system further provides a module for determining whether a least a portion of the cost savings is attributable to a usage substitution, a module for calculating an amount of the usage substitution cost savings, a module for determining whether a least a portion of the cost savings is attributable to a price or a leakage, a module for calculating an amount of the price or leakage cost savings, a module for determining whether at least a portion of the cost savings is attributable to a one time event, a module for calculating an amount of the one-time event cost savings, and a module for calculate the cost savings based upon the plant and equipment cost savings, the acquisition cost savings, the outsourcing or insourcing cost savings, the disposition cost savings, the usage substitution cost savings, the price or leakage cost savings, and the one-time expense cost savings.

Another exemplary embodiment of the invention provides a system for calculating and attributing cost reductions using a decision matrix to facilitate consistent attribution, where the system comprises a module for performing a plurality of determinations for attributing at least a portion of the cost reduction to at least one class, a module for calculating the class cost savings for each class to which a portion of the cost reduction has been attributed, and a module for calculating the total cost savings based on each of the class cost savings.

### BRIEF DESCRIPTION OF THE FIGURES

FIGS. 1A and 1B are a flow-chart of a decision matrix according to an embodiment of the invention.

FIG. 2 illustrates a graphic user interface for presenting a decision matrix process for an Outsourcing/Insourcing class cost savings determination according to an embodiment of the invention.

FIG. 3 illustrates a savings report from an Outsourcing/Insourcing class cost savings determination according to an embodiment of the invention.

FIG. 4 illustrates a graphic user interface for presenting a decision matrix process for a Usage/Substitution class cost savings and a Price/Leakage class cost savings according to an embodiment of the invention.

FIG. 5 illustrates a savings template decision matrix for a Usage/Substitution class cost savings and a Price/Leakage class cost savings determination according to an embodiment of the invention.

FIG. 6 illustrates a savings calculation from a Usage/Substitution class cost savings and a Price/Leakage class cost savings determination according to an embodiment of the invention.

FIG. 7 illustrates a graphic user interface for presenting a decision matrix process for a One-Time Expense class cost savings determination according to an embodiment of the invention.

FIG. 8 illustrates a savings template decision matrix for a One-Time Expense class cost savings determination according to an embodiment of the invention.

FIG. 9 illustrates a savings calculation from a One-Time Expense class cost savings determination according to an embodiment of the invention.

FIG. 10 is a system for implementing a decision matrix according to an embodiment of the invention.

### DETAILED DESCRIPTION OF THE INVENTION

Reference will now be made in detail to the present preferred embodiments of the invention, examples of which are illustrated in the accompanying drawings in which like reference characters refer to corresponding elements.

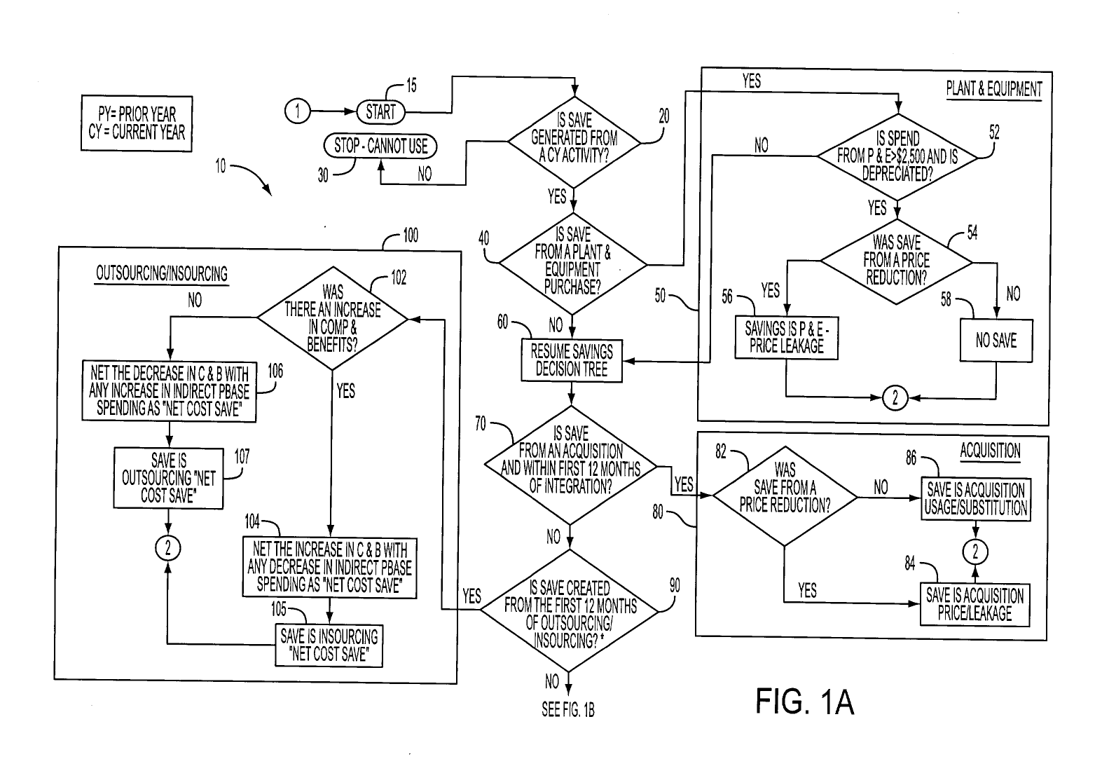

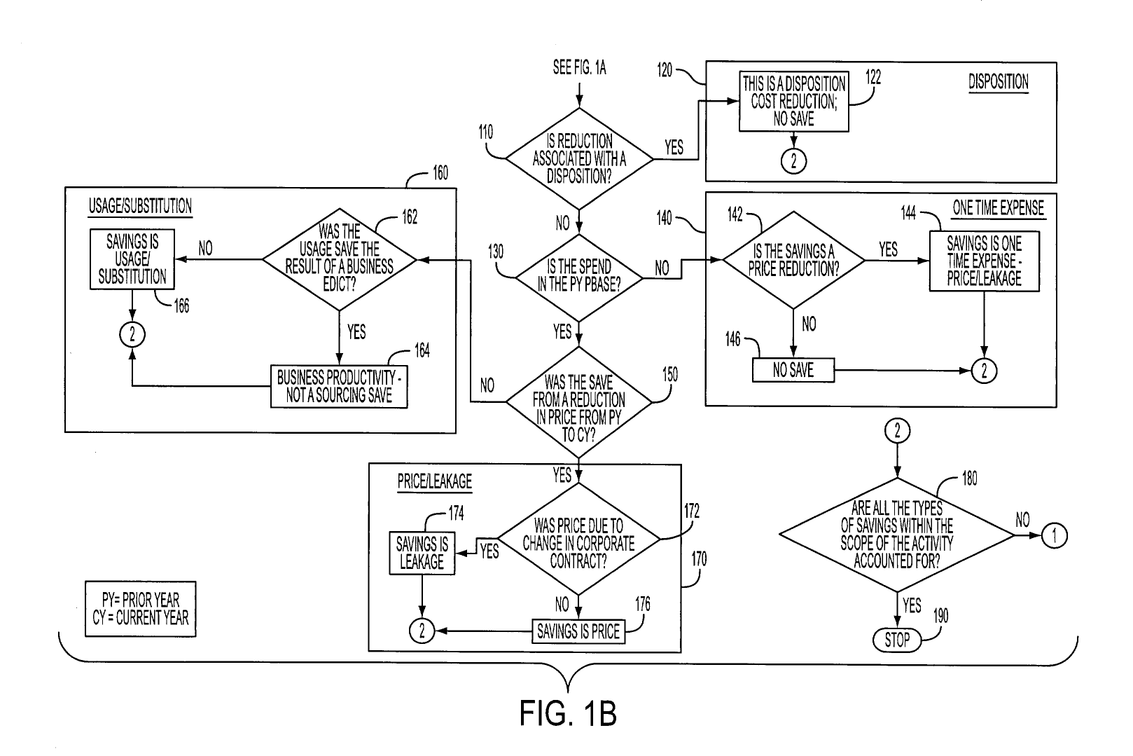

As stated above, a process and system is provided for facilitating consistent calculation and attribution of cost savings within an organization. FIGS. 1A and 1B are a flow-chart 10 for a decision matrix according to an embodiment of the invention. Cost reductions are analyzed and attributed to the appropriate cost savings class. While FIGS. 1A and 1B illustrate an embodiment of a cost savings decision matrix, it will be apparent to one of ordinary skill in the art that one or more steps may be added, omitted and/or rearranged in the process illustrated in the flow-chart without departing from the scope of the invention.

At step 15, a user starts the process. At step 20, the user determines whether there are cost reductions generated from a current year activity. If cost reductions were not generated in the current year, then the process ends at step 30. If cost reductions were generated from a current year activity, the user determines at step 40 whether the cost reduction is from a plant and equipment purchase.

If cost reductions were generated from a plant and equipment purchase, the user determines, in portion 150 of flow chart 10, if the cost savings, or some portion thereof, are attributable to the Plant and Equipment Purchase class. Plant and Equipment Purchase class may be used for cost reduction which are attributable to capital purchases, such as purchases of new equipment, investments in existing equipment, investments in work space (office, production facilities, etc.), new work space purchases or leases, buildings, leasehold improvements, furniture and equipment, printers, servers or other similar monetary expenditures. At step 52, the user determines if spending in the Plant and Equipment Purchase class is greater that a predetermined amount and is depreciated. In the particular example illustrated in step 52 of FIGS. 1A and 1B, the predetermined amount is $2,500.00. However, any amount, as appropriate for an organization implementing the present invention, may be used. In the embodiment illustrated in FIGS. 1A and 1B, depreciation is considered because an asset's entire costs may be seen on a balance sheet. That is, depreciation may be the only expense that will be recorded on an income statement in a year. Depreciation may be used for capital purchases. However, depreciability may be ignored and/or other factors considered, as appropriate for the organization.

If the spending is greater than the predetermined amount, the user determines if the savings was from a price reduction at step 54. If the cost reduction were from a price reduction, the cost reduction is attributed to the Plant and Equipment Price/Leakage class cost savings at step 56. If the cost reduction was not from a price reduction, than no cost savings are attributed at step SB. For either scenario, the user then proceeds to step 180 to determine if all cost reductions within the scope of a particular activity have been accounted. If the answer is yes, the user proceeds back to step 15 to continue the savings decision matrix process 10. If the answer is no, the user ends the process at step 190.

By way of an illustrative example for calculating cost savings in a Plant and Equipment Purchase class cost savings, assume that an organization decides to renovate one of its office areas in a building it is currently licensing. Part of the renovation involves purchasing new work stations for a number of employees currently occupying cubical space. A first supplier that was providing materials to other tenants leasing space within the building offered the workstations at a list price of $2,400 per workstations. The first supplier and two other vendors then participated in an auction to supply 500 workstations (that will be depreciated), where the first supplier offered $2,049 per station versus $2,055 and $2,051 per station for the other vendors.

From this, the baseline bid is first determined by taking the average of the first bid and the awarded bid. In this example, the baseline bid is $2,224.50 (($2,400+$2,049)/2). The cost savings are then calculated by subtracting the award bid from the baseline bid, and multiplying by the current year's units. Thus, the Plant and Equipment Purchase class cost savings are $87,750 (($2,224.50−$2049.00)*500). Other algorithms for calculating savings may also be used.

If the cost reduction is not from a plant and equipment purchase (step 40) or the spending is less than a predetermined amount (step 52), the user returns to step 60 and resumes the savings decision matrix process. At step 70, the user determines if the cost reduction occurred from an acquisition and within a predetermined amount of time of integration of the acquisition. In the particular example illustrated in step 70 of FIGS. 1A and 1B, the predetermined amount of time is twelve months. However, any amount of time, as appropriate for an organization implementing the present invention, may be used.

If the user answers yes, the user determines, in Acquisition portion 80 of flowchart 10, the proper Acquisition class attribution. Acquisition classes may be used for acquisitions of companies, divisions of companies, departments, services, products, assets of another company, or similar expenditures related to mergers or reorganizations. At step 82, the user determines if the cost reduction is from a price reduction. If not, the cost reduction is attributed to an Acquisition Usage/Substitution class cost savings at step 84. If yes, the cost reduction is attributed to an Acquisition Price/Leakage class cost savings at step 86. For either scenario, the user then proceeds to step 180 as described above.

By way of an illustrative example for calculating cost savings in the Acquisition Usage/Substitution class, assume that due to an acquisition, an organization using the process of the present invention launched a new initiative earlier in the year. This effort focused on consolidating similar office functions into a central location. The new arrangement was finalized in October, and all moves were completed in November. The initial budget planned for 300 printers at a monthly cost of $30 per printer, for a total printer budget of $108,000 (300*12*30). The consolidation has resulted in a reduction of the number of required printers from 300 to 200, which will go into effect on December 1 with the new printer contract. From this, the total savings are calculated by subtracting the current year units from the previous year units and multiplying by the previous years price. Thus, the current years cost savings are $3,000 ((300−200)*30), the carryover cost savings are $33,000 ((300−200)*11*30), and the total cost savings are $36,000. Other algorithms for calculating savings may also be used.

If a cost reduction was determined not to have be attributable to an acquisition (step 70), the user then determines if the cost reduction occurred from an outsourcing or insourcing decision over a predetermined period of time at step 90. In the particular example illustrated in step 90 of FIGS. 1A and 1B, the predetermined amount of time is twelve months. However, any amount of time, as appropriate for an organization implementing the present invention, may be used.

If a cost reduction occurred from an outsourcing or insourcing decisions over a predetermined period of time, the user determines, in Outsourcing/Insourcing Portion 100 of flow-chart 10, the appropriate attribution for the cost reduction. At step 100, the user determines if there was an increase in the overall compensation and benefits due to the outsourcing or insourcing decision. If there was no increase, or there was a decrease, the cost reduction should be netted with any increases in indirect base spending at step 106, thereby calculating a net cost reduction. According to an embodiment of the invention, indirect base spending may be any spending not attributable to compensation and benefits, such as leasing equipment, telephones and other spending. The cost reduction is then attributed to the Outsourcing Net Cost Savings class cost savings at step 107. If there was an increase, the additional costs should be net with any decrease in the indirect base spending at step 104, thereby calculating a net cost reduction. The cost reduction is the attributed to the Insourcing Net Cost Savings class cost savings at step 105. For either scenario, the user then proceeds to step 180 as described above.

According to an embodiment of the invention, outsourcing or insourcing decisions may comprising recognizing the set up costs in the first year and recognizing the remaining savings outside the first twelve months. By way of example, as illustrated in the table below, current costs may be $25 per quarter, or $100 per year, new costs after outsourcing may $12 per quarter, or $48 per year, and set up costs may be a one time charge of $12.

| | | Year 1 | | | | Year 2 | | | |
|---|---|---|---|---|---|---|---|---|---|
| | Year 0 | Q1 | Q2 | Q3 | Q4 | Q1 | Q2 | Q3 | Q4 |
| Current cost | 100 | 25 | | | | | | | |
| Set up cost | | | 12 | | | | | | |
| New cost | | | 12 | 12 | 12 | 12 | 12 | 12 | 12 |
| Total cost | 100 | 25 | 24 | 12 | 12 | 12 | 12 | 12 | 12 |

For a change instituted in the second quarter, the first year costs are calculated as $73 ($25+$12+$12+$12+$12), while second year costs are calculated as $48 ($12*4). Thus, the savings for year one are ($100−$73) $27, the savings for year two are ($73−$48) $25, and the total savings are ($27+$25) $52. Other algorithms for calculating savings for outsourcing or insourcing decisions may also be used.

If the cost savings did not occur due to an outsourcing or insourcing decision, the user determines whether the cost reduction is associated with a disposition at step 110. If yes, the user determines, in Disposition portion 120 of flow-chart 10, the proper Disposition class. A Disposition may comprise disposing of a particular division, product line, asset, or other similar dispositions. At step 122, a disposition cost reductions is not considered a cost savings. However, as appropriate for an organization, one or more Disposition class may be used and classified as a cost savings. The user then proceeds to step 180 as described above.

If the cost reduction is not associated with a disposition, the user determines if the spending associated with the cost reduction was based on a previous year purchase base at step 130. If not, the user determines, in One Time Expense portion 140 of flow-chart 10 the proper One Time Expense class. A one time expense may comprise any purchase of goods and/or services that will occur only in one year and that did not occur in the prior year. At step 142, the user determines if the cost reduction was from a price reduction. If yes, the cost reduction is attributed to a One Time Expense Price/Leakage class cost savings at step 144. If not, then the one time reduction is not considered a cost savings at step 146. However, as appropriate for an organization, such a one time expense may be classified as a cost savings. For either scenario, the user then proceeds to step 180 as described above.

If the spending was in a previous year purchase base, the user determines whether the cost reduction from the reduction in cost occurred due to a reduction in price from the previous year to the current year at step 150. If no, the user determines, in Usage/Substitution portion 160 of flow-chart 10, the appropriate Usage/Substitution class. A Usage/Substitution class may comprise cost reductions attributed to changes of using particular assets, substituting one asset for another, changing service providers, changing a process to improve productivity, using different software or platform, or other similar types of actions. A Usage/Substitution class cost savings may also comprise changes that result in a longer mean time thereby—between failures or repairs, increasing the service life and lowering total usage. At step 162, the user determines if the cost reduction attributed to usage was the result of a business edict. If not, the cost reduction are attributed to a Usage/Substitution class cost savings at step 166. If yes, the cost reduction is not categorized as a cost savings at step 164, as it is the function of business productivity, not a sourcing savings. However, it is understood that as appropriate for an organization, a cost reduction due to a business edict may be classified as a cost savings. For either scenario, the user then proceeds to step 180 as described above.

If the savings from the cost reduction did occur due to a reduction in price from the previous year to the current year (step 150), the user determines, at Price/Leakage portion 170 of flow-chart 10, the appropriate Price/Leakage class. A Price/Leakage Class may comprise cost reductions attributed to contract price negotiations or auctions, receiving a better price for the same type of expense from a different company, a combination thereof or other cost reductions. At step 172, the user determines if a price change occurred because of a change in the corporate contract. If yes, the cost reduction is attributed to the Leakage class cost savings at step 174. If not, the cost reduction is attributed to the Price class cost savings at step 176. For either scenario, the user then proceeds to step 180 as described above.

According to an embodiment of the invention, a cost reduction may be attributed to both on Usage/Substitution class cost savings and a Price/Leakage class cost savings. By way of an illustrative example, for calculating cost savings in the Usage/Substitution and Price/Leakage classes, assume that annual growth for an organization using the process of the present invention necessitates an internal review of all commodity purchase forecasts. One analysis estimated that the cost of 8½×11 copy paper will increase 15-20% annually over the next three years, while the organizations digitization efforts will allow the use of less paper. To lock into a long-term contract with a single supplier, a request for quotations is prepared using previous year's usage and future year's estimates. With $15.00 per box being the current price, four suppliers provided firm quotes of $15.35, $15.05, $14.25 and $14.10 per box, respectively. Current paper usage is 10,000 boxes a year, while usage is expected to decrease to 9,500 boxes beginning in November of the current year. The contract is for three years and begins on November 1 of the current year.

To calculate savings, both Usage/Substitution and Price/Leakage class cost savings must be calculated. For the Usage/Substitution class, the current year's usage subtracted from the previous year's usage multiplied by the previous years price may provide the cost savings. In this example, cost savings are $7,500 ((10,000−9,500)*$15.00), with $1,250 of current year cost savings and $6,250 in carryover cost savings. For the Price/Leakage class, the current year's price subtracted from the previous year's price, multiplied by the current year's usage may provide the Price class cost savings (as the price change is not due to an overall corporate contract change). In this example, the cost savings are $8,550 ($15.00−$14.10)*9,500), with $1,425 in current year savings and $7,125 in carryover cost savings. Other algorithms may be used to calculate.

According to an embodiment of the invention, an organization may provide certain instructions and explanations on appropriate use of the process of FIGS. 1A and 1B. By way of example only, a user may be instructed that the decision matrix may be used to classify a cost reduction that occurs for the first time in the current year, where carryover savings are not re-classified if they overlap another calendar year. Other instructions may include informing a user that savings should only be recorded for a predetermined period of time (e.g., twelve months) with appropriate exceptions (e.g. insourcing/outsourcing decisions), and that savings must be in one of the indirect purchase base accounts for savings to be included within particularly categories (e.g., usage/substitution, price/leakage, avoidance categories, etc.). Other instructions may also be provided.

According to an embodiment of the invention, a user may be required to work through all facets of an initiative through a decision matrix process (e.g., an indirect savings decision matrix) until all facets of the initiative have been classified into one or more cost savings categories. For example, there may be both price and usage cost savings from the same initiative.

According to an embodiment of the invention, a decision matrix process may comprise the use of one or more algorithms and macros in a spreadsheet environment, such as Microsoft Excel, Lotus 1, 2, 3, or other spreadsheet environments. Algorithms and macros may be used to query a user for information regarding cost reduction projects and initiatives, and use the resulting information to calculate the current year savings, carryover savings, volumes and other savings information, as well as attribute cost savings to the appropriate cost savings class and/or classes. Initial queries may be made, with follow-up queries based on the preceding query. A user may be guided through the process. According to an embodiment of the invention, a user may be prevented with mostly yes or no questions, thereby eliminating many assumptions. Further, terms which may be potentially confusing may be operationally defined, such as by using cell comments (e.g., a user moves a selector over a cell having a confusing term and the definition is provided).

According to an embodiment of the invention, automated calculations and cost savings class attributions may enable more accurate and consistent reporting of cost reductions within an organization. The algorithms and macros used may provide a more consistent approach to calculations and attributions, thereby eliminating some bias of a user and reducing the variability across an organization.

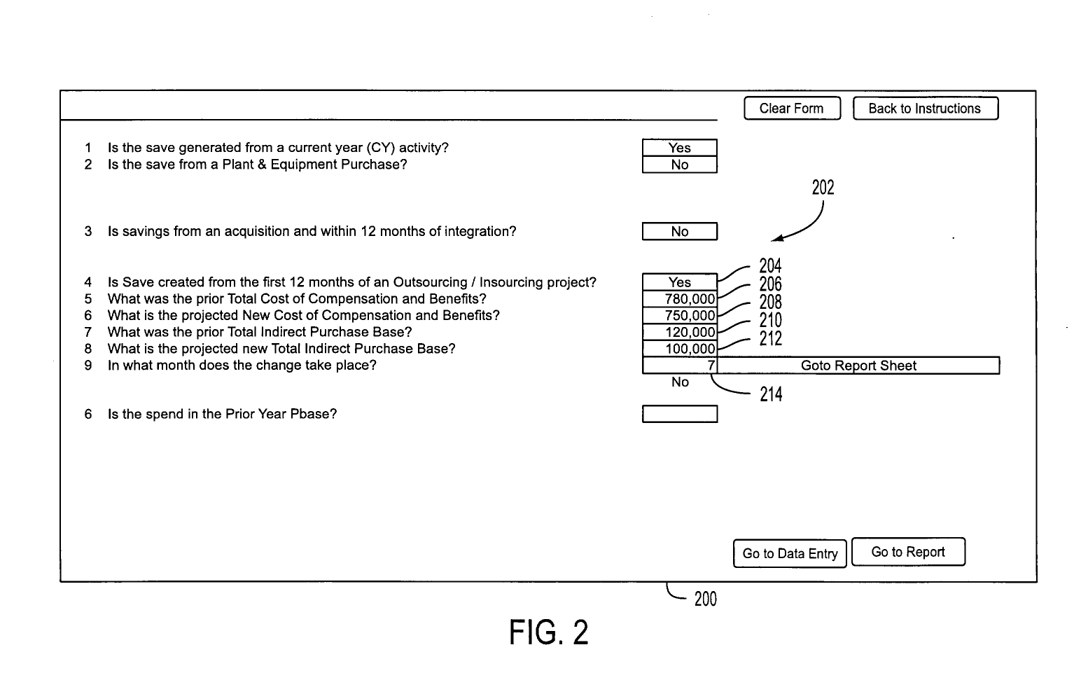

FIGS. 2-9 illustrate various examples of a graphical user interface for presenting a decision matrix process and resulting displays according to an embodiment of the invention.

FIG. 2 illustrates a graphic user interface for presenting a decision matrix process for an Outsourcing/Insourcing class cost savings determination according to an embodiment of the invention. Display 200 provides a number of questions 202 to a user. According to an embodiment of the invention, each question presented to a user may be based on the answer provided by the user to the previous question. Thus, in the illustration presented in FIG. 2, when a user answers yes to question 204 (e.g., is save created from the first 12 months of an Outsourcing/Insourcing project), the user may next be presented with questions regarding the amounts at issue.

By way of an illustrative example of calculating cost savings in an Outsourcing class, assume that an organization has experienced growth in Latin and South America over the past year. Presently, the organization has fifteen people working in the region, with a compensation and benefits cost of $780,000 and other operating expenditures of $120,000, for a total annual cost of $900,000. However, outsourcing may enable reduced costs, with only about $100,000 in internal costs. A solicitation of bids resulted in three proposals of equal merit at the price of $750,000, $765,000 and $795,000 per year respectively. The low bid supplier is chosen, effective July 1 of the current year. From this, the total cost savings may be calculated by subtracting the current year's costs, comprising outsource spending and baseline costs, from the previous year's costs, comprising in-housing spending and baseline costs. Thus, total savings are $50,000 (($780,000+$120,000)−($100,000+$750,000)), with current year's cost savings of $25,000 and carryover cost savings of $25,000. Other algorithms for calculating savings for outsourcing or insourcing decisions may also be used.

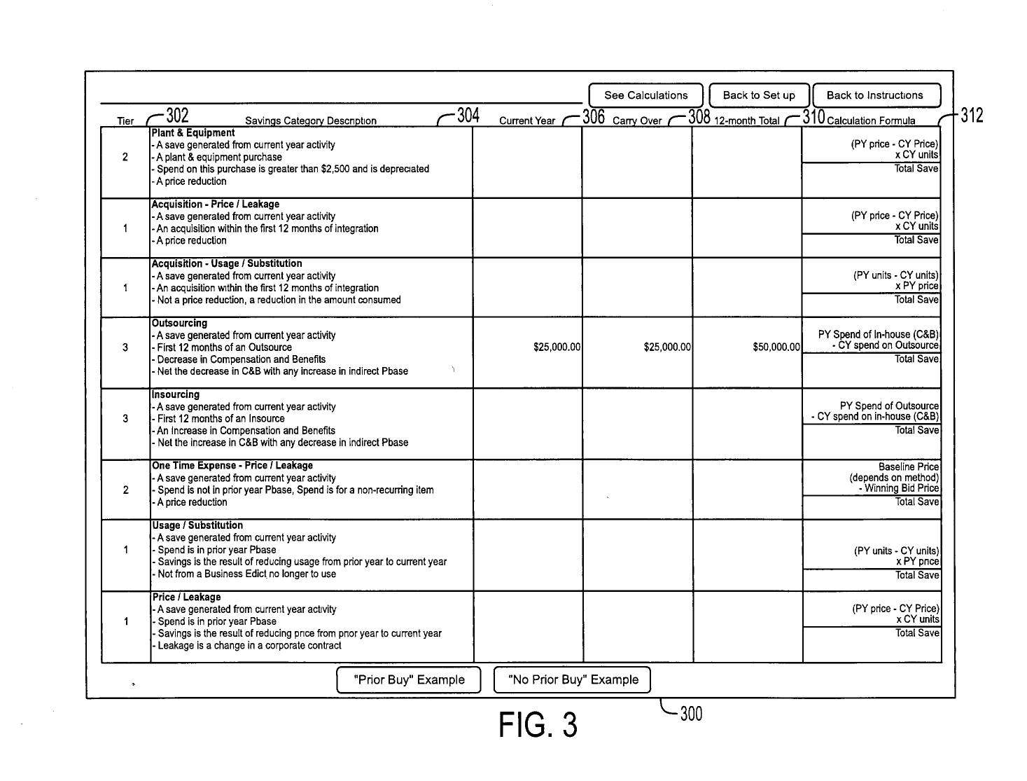

As illustrated in FIG. 2, a user, upon answering yes to question 204, is asked to provide the prior total cost of compensation and benefits at question 206 and the projected new cost of compensation and benefits at question 208. The user is also asked to provide the prior total indirect purchase base at question 210, and the projected total indirect purchase base at question 212. Upon selecting the month the change takes place at question 214, the user is directed to go to a savings report sheet 300 from an Outsourcing/Insourcing class cost savings determination, according to an embodiment of the invention, as illustrated in FIG. 3. Savings report 300 presents a user with a break-down of cost savings attributed to various classifications. According to the example illustrated in FIG. 3, column 302 provides a tier ranking for each classification, while column 304 provides a description of each cost savings classification. While the illustration of FIG. 3 depicts Plant and Equipment, Acquisition Price/Leakage, Acquisition Usage/Substitution, Outsourcing, Insourcing, One Tine Expense Price/Leakage, Usage/Substitution, Price/Leakage cost savings, it is understood that other classifications may also be displayed and described.

Further, column 306 provides the cost savings for the current year, column 308 provides the carry over cost savings, column 310 provides the twelve month total of cost savings, and column 312 provides the cost savings calculation formula. In the above example, $25,000 is displayed in current year cost savings column 306, in the row defined of the Outsourcing cost savings. Carry over cost savings are displayed as $25,000, and the twelve month total cost savings are displayed as $50,000 in the appropriate rows of columns 308 and 310, respectively. Other beak-downs of cost savings may also be used. Further, it is understood that multiple cost savings classifications may be displayed for one or more cost reduction initiatives.

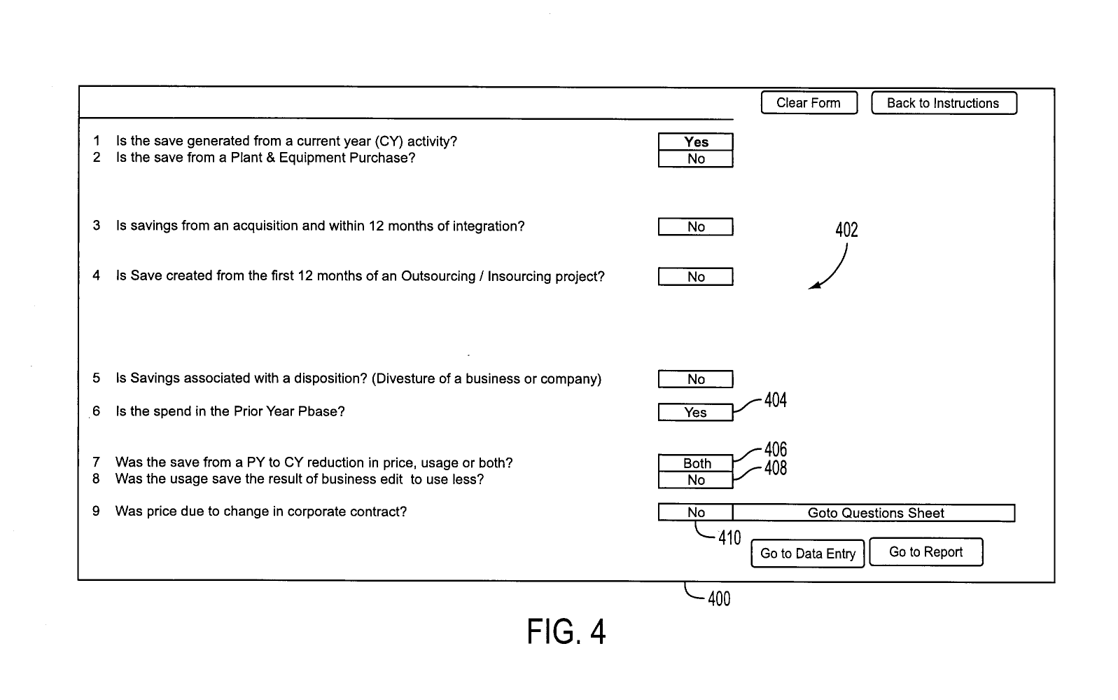

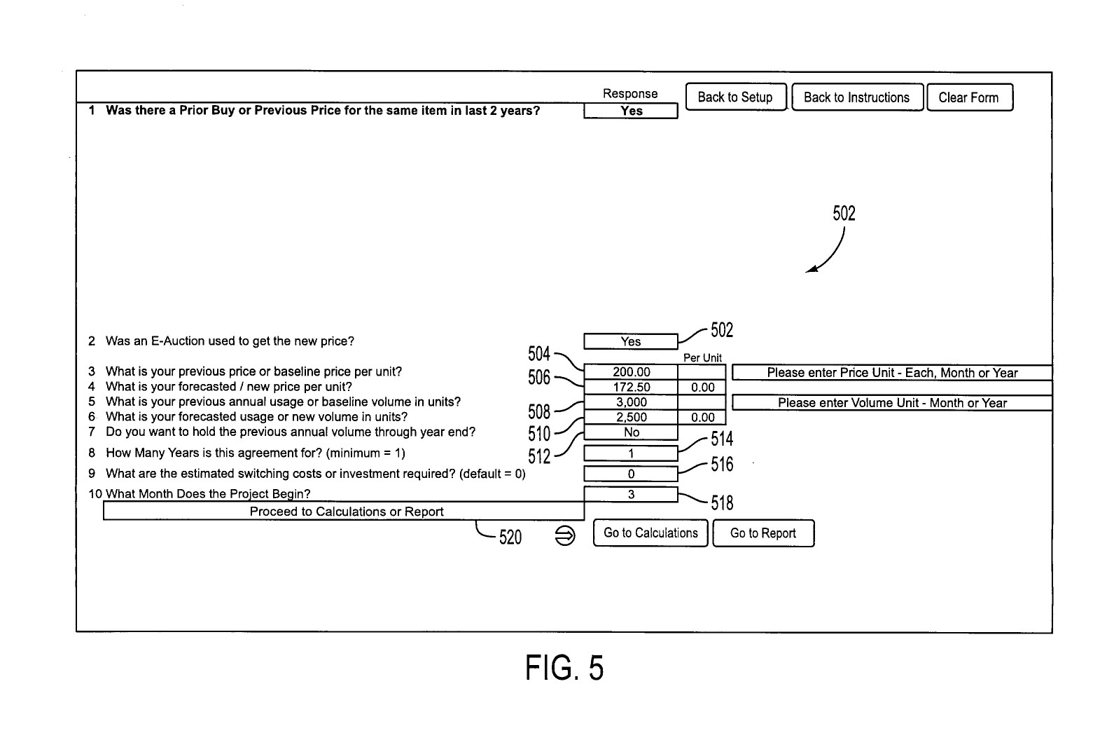

FIG. 4 illustrates a graphic user interface for presenting a decision matrix process for a Usage/Substitution class cost savings and a Price/Leakage class cost savings according to an embodiment of the invention. Display 400 provides a number of questions 402 to a user. According to an embodiment of the invention, each question presented to a user may be based on the answer provided by the user to the previous question. Thus, in the illustration presented in FIG. 4, when a user answers yes to question 404 (e.g., is the spending in the prior year purchase base), the user may next be presented with additional questions. Specifically, as illustrated in FIG. 4, a user is asked at question 406 whether the cost reduction was from a reduction in price, a reduction in usage, or both. At question 408, a user is asked whether the cost savings resulted form a business edict to use less. A user is asked whether the price change was due to a change in a corporate wide contract at question 410. Based on the particular answers, the user is directed to a savings template for a Usage/Substitution class cost savings and a Price/Leakage class cost savings determination according to an embodiment of the invention, as illustrated in FIG. 5.

FIG. 5 illustrates a graphic user interface 500 for calculating savings. Various questions 502 are presented to a user to assist in determining the proper cost savings classification and calculations. While FIG. 5, illustrates a Usage/Substitution class cost savings and a Price/Leakage class cost savings determination, other determination may also be made. At question 502, a user is asked in an electronic auction was used. The user is asked to provide the previous price or baseline price at question 504 and the forecasted or new price at question 506. In the present example, the user has indicated that the previous price was $200 a unit, while the new price is $172.50 a unit. At question 508, a user is asked to provide the previous annual usage or baseline volume, and the is asked to provide the forecasted annual usage or volume at question 510. In this example, the user has indicated that previous usage was 3,000 units, while the forecasted usage is 2,500 units.

At question 514, a user is prompted to provide the length of the agreement in years, while at question 516, the user is prompted to indicate the estimated switching costs. Further, at question 518, the user is asked to indicate what month the project will begin. In the present example, the user indicates that the length of the agreement is one year (to question 514), there are no estimated switching costs (question 516) and that the project begins in March (question 518). At 520, the user is prompted to proceed to a calculation sheet or a cost savings report.

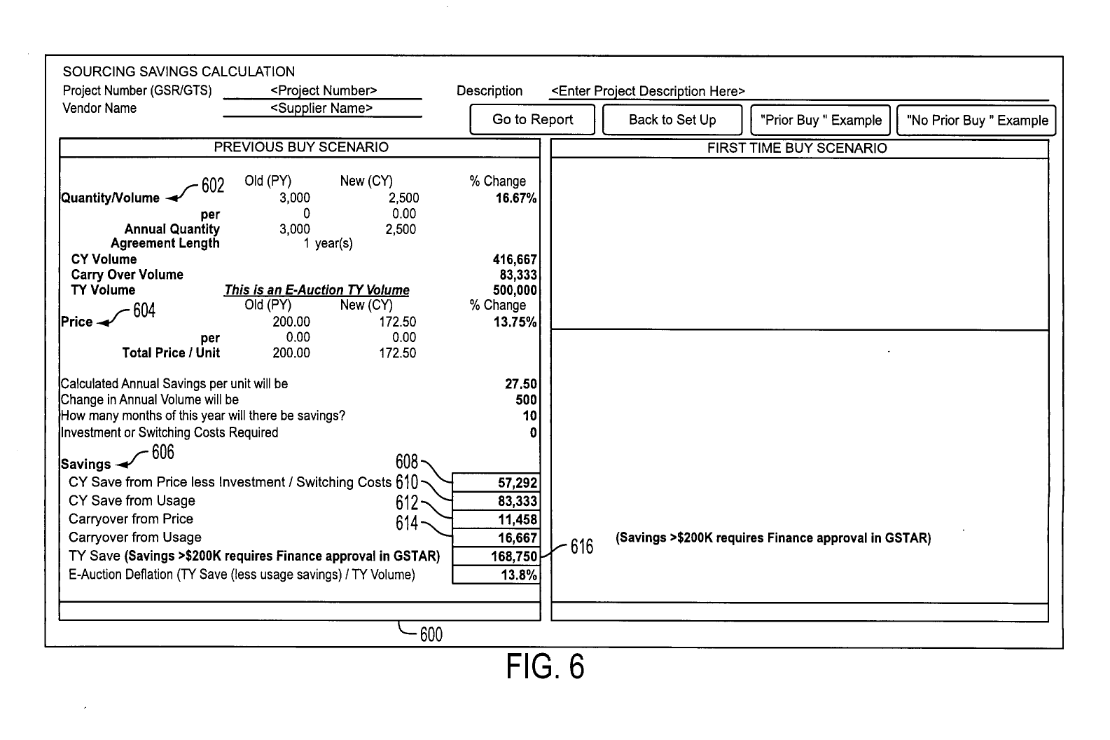

FIG. 6 illustrates a savings calculation sheet from a Usage/Substitution class cost savings and a Price/Leakage class cost savings determination according to an embodiment of the invention. Graphic interface 600 presents information to a user related to a cost savings calculation. In the present example, section 602 presents information related to the quantity and volume, such as the current year's volume, the carry over volume and the total volume. Section 604 presents information to a user related to price, such as previous year's price, current year's price and the change in price. Section 606 presents a user information related to savings. At portion 608, the current year cost savings, less any costs from switching, is provide, where the amount is $57,292 in the present example. Portion 610 presents $83,333 as the current years savings from usage. Portion 612 presents $11,458 as the carryover savings from usage, while portion 614 presents $16,667 as the carryover savings from price. Portion 616 presents $168,750 as the total savings. Other information may also be provided in calculation sheet 600.

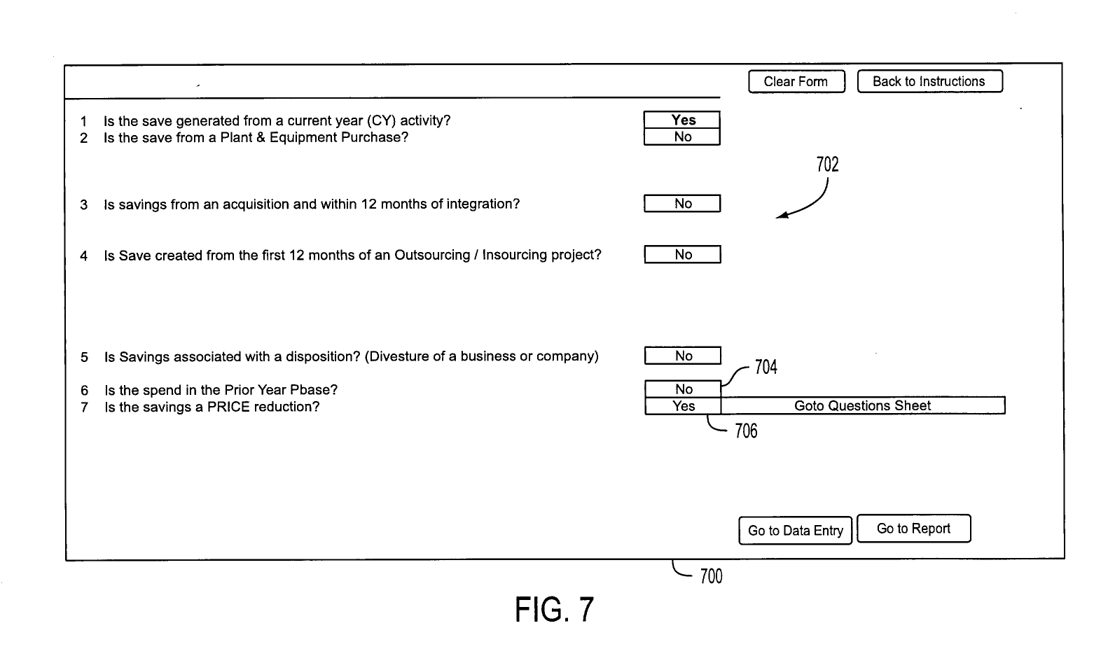

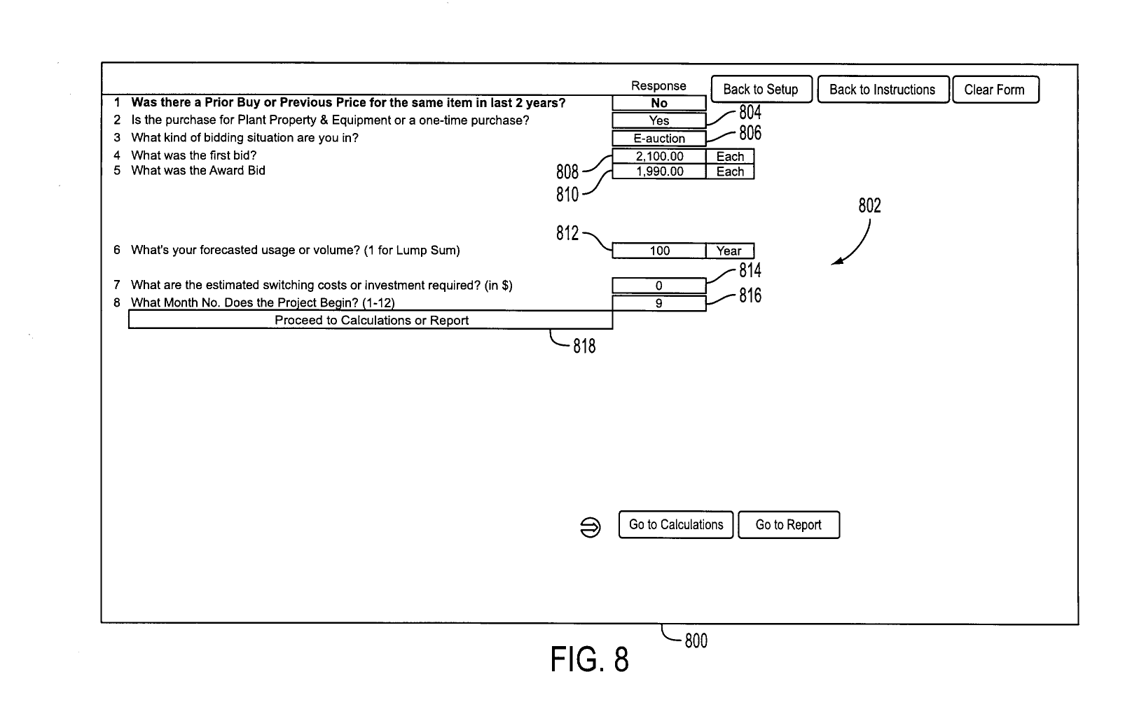

FIG. 7 illustrates a graphic user interface for presenting a decision matrix process for a One-Time Expense class cost savings determination according to an embodiment of the invention. Display 700 provides a number of questions 702 to a user. According to an embodiment of the invention, each question presented to a user may be based on the answer provided by the user to the previous question. Thus, in the illustration presented in FIG. 7, when a user answers no to question 704 (e.g., is the spending in the prior year purchase base), the user may next be presented with additional questions. Specifically, as illustrated in FIG. 7, a user is asked at question 706 whether the cost reduction was from a reduction in price. In this example, the user answers no and is instructed to proceed to a savings template, as illustrated in FIG. 8.

FIG. 8 illustrates a graphic user interface for calculating savings for a One-Time Expense class cost savings determination according to an embodiment of the invention. Various questions 802 are presented to a user to assist in determining the proper cost savings classification and calculations. While FIG. 8 illustrates a One-Time Expense class cost savings, other determination may also be made. At question 804, a user is asked if this is a one-time purchase. The user is asked to indicate what type of bidding was used at question 806. At question 808, the user is prompted to identify the amount and units of the first bid, and at question 810, the user is prompted to identify the amount and units of the winning bid. In the present example, the user has indicated that the first bid was $2,100 per unit (question 808), while the winning bid was $1,990.00 per unit (question 810). At question 812, a user is asked to provide the forecasted usage or volume, which in this example has been designated at 100 per year. At question 814, the user is prompted to indicate the estimated switching costs, while at question 816, the user is asked to indicate what month the project will begin. In the present example, the user indicates that there are no estimated switching costs (question 814) and that the project begins in September (question 816). At 818, the user is prompted to proceed to a calculation sheet or a cost savings report.

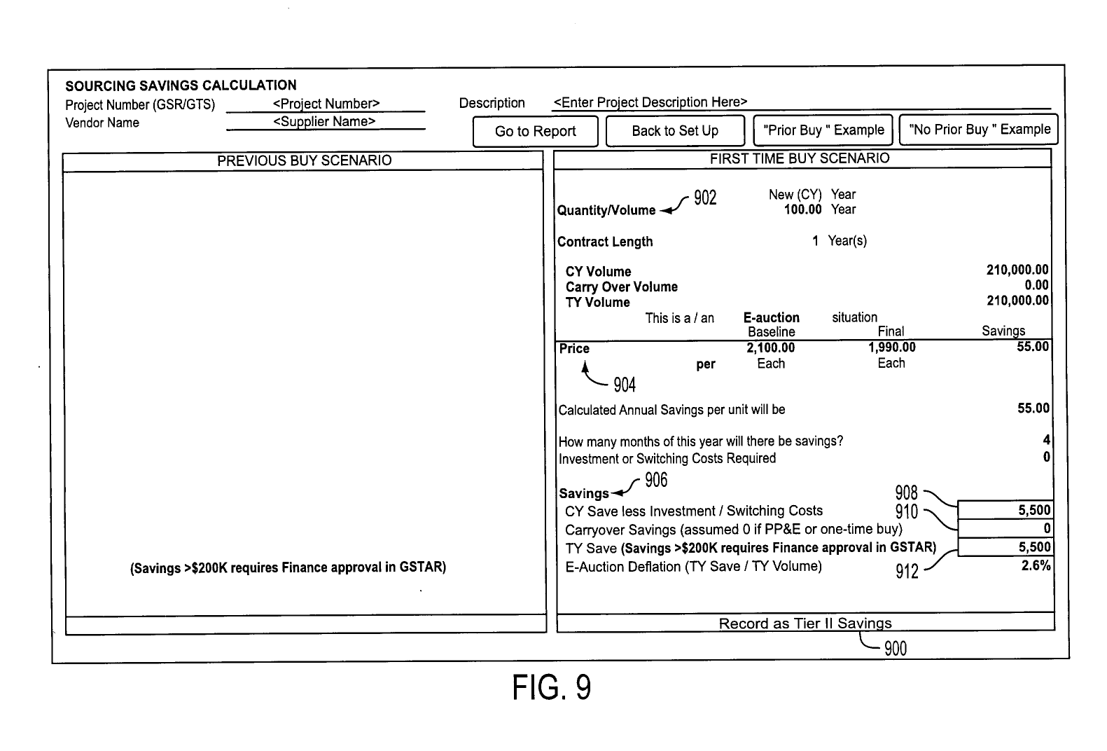

FIG. 9 illustrates a savings calculation sheet from a One-Time Expense class cost savings determination according to an embodiment of the invention. Graphic interface 900 presents information to a user related to a cost savings calculation. In the present example, section 902 presents information related to the quantity and volume, such as the current year's volume, and the contract length. Section 904 presents information to a user related to price, such as the baseline price, the current year's price and the savings per unit. Section 906 presents a user information related to savings. At portion 908, the current year cost savings, less any costs from switching, is provide, where the amount is $5,500 in the present example. Portion 910 presents $0 as the carryover savings, while portion 912 presents $5,500 as the total savings. Other information may also be provided in calculation sheet 900.

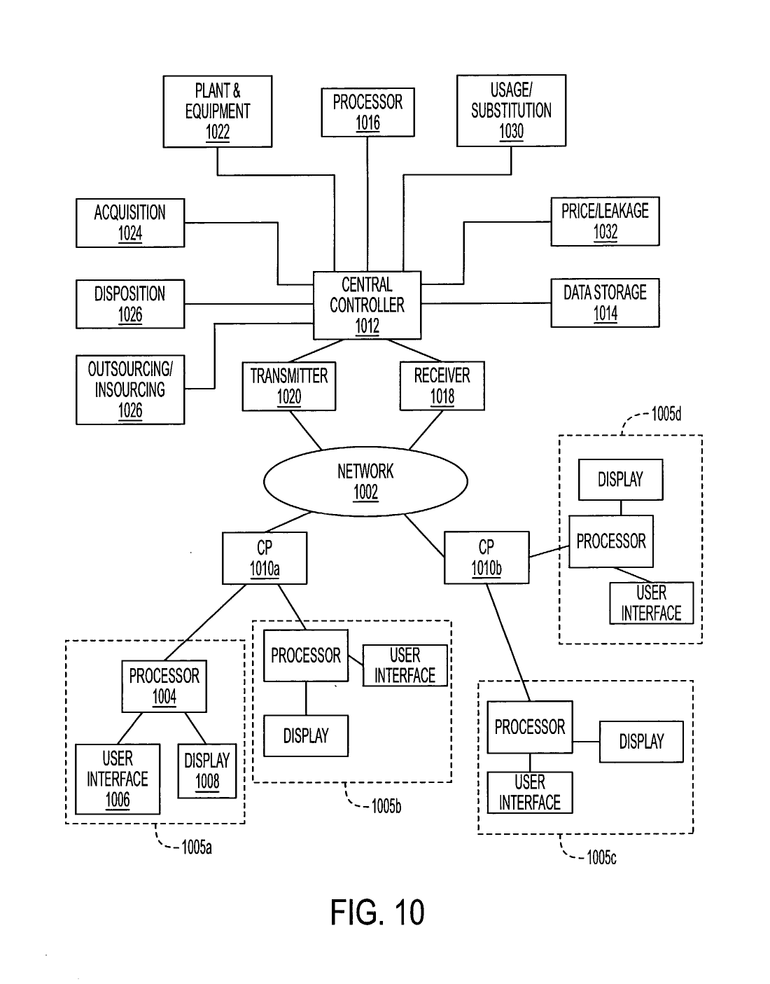

FIG. 10 illustrates a system 1000 according to an embodiment of the present invention. The system 1000 comprises a plurality of computer devices 1005 (or “computers”) used by a plurality of users to connect to a network 2002 through a plurality of connection providers (CPs) 1010. The network 1002 may be any network that permits multiple computers to connect and interact. According to an embodiment of the invention, the network 1002 may be comprised of a dedicated line to connect the plurality of the users, such as the Internet, an intranet, a local area network (LAN), a wide area network (WAN), a wireless network, or other type of network. Each of the CPs 1010 may be a provider that connects the users to the network 1002. For example, the CP 1010 may be an Internet service provider (ISP), a dial-up access means, such as a modem, or other manner of connecting to the network 1002. In actual practice, there may be significantly more users connected to the system 2000 than shown in FIG. 10. This would mean that there would be additional users who are connected through the same CPs 1010 shown or through another CP 1010. Nevertheless, for purposes of illustration, the discussion will presume three computer devices 1005-1005d are connected to the network 1002 through two CPs 1010.

According to an embodiment of the invention, the computer devices 1005a-1005d may each make use of any device (e.g., a computer, a wireless telephone, a personal digital assistant, etc.) capable of accessing the network 1002 through the CP 1010. Alternatively, some or all of the computer devices 1005a-1005d may access the network 1002 through a direct connection, such as a Ti line, or similar connection. FIG. 10 shows the three computer devices 1005a-1005c, each having a connection to the network 1002 through the CP 1010a and the CP 1010b. The computer devices 1005a-1005d may each make use of a personal computer such as a computer located in a user's home, or may use other devices which allow the user to access and interact with others on the network 1002. A central controller module 1012 may also have a connection to the network 1002 as described above. The central controller module 1012 may communicate with one or more modules, such as one or more data storage modules 1014, one or more processor modules 2016, or other modules discussed in greater detail below.

Each of the computer devices 1005a-1005d used may contain a processor module 1004, a display module 1008, and a user interface module 1006. Each of the computer devices 1005a-1005d may have at least one user interface module 1006 for interacting and controlling the computer. The user interface module 1006 may be comprised of one or more of a keyboard, a joystick, a touchpad, a mouse, a scanner or any similar device or combination of devices. Each of the computers 1005a-1005d may also include a display module 1008, such as a CRT display or other device. According to an embodiment of the invention, a developer, a user of a production system, and/or a change management module may use a computer device 1005.

The central controller module 1012 may maintain a connection to the network 1002 such as through a transmitter module 1020 and a receiver module 1018. The transmitter module 1020 and the receiver module 1018 may be comprised of conventional devices that enable the central controller module 1012 to interact with the network 1002. According to an embodiment of the invention, the transmitter module 1020 and the receiver module 1018 may be integral with the central controller module 1012. According to another embodiment of the invention, the transmitter module 1020 and the receiver module 1018 may be portions of one connection device. The connection to the network 1002 by the central controller module 1012 and the computer devices 1005 may be a high speed, large bandwidth connection, such as through a T1 or a T3 line, a cable connection, a telephone line connection, a DSL connection, or another similar type of connection. The central controller module 1012 functions to permit the computer devices 1005a-1005c to interact with each other in connection with various applications, messaging services and other services which may be provided through the system 1000.

The central controller module 1012 preferably comprises either a single server computer or a plurality of server computers configured to appear to the computer devices 1005a-1005d as a single resource. The central controller module 1012 communicates with a number of modules. Each module will now be described in greater detail.

A processor module 1016 may be responsible for carrying out processing within the system 1000. According to an embodiment of the invention, the processor module 1018 may handle high-level processing, and may comprise a math coprocessor or other processing devices.

A Plant and Equipment module 1022 may be responsible for carrying out functions related to Plant and Equipment class cost savings. According to an embodiment of the invention, Plant and Equipment module 1022 may handle appropriate questions and answers related to the Plant and Equipment class as well as instructions for the user.

An Acquisition module 1024 may be responsible for carrying out functions related to Acquisition class cost savings. According to an embodiment of the invention. Acquisition module 1024 may handle appropriate questions and answers related to the Acquisition class as well as instructions for the user.

An Outsourcing/Insourcing module 1026 may be responsible for carrying out functions related to Outsourcing/Insourcing class cost savings. According to an embodiment of the invention. Outsourcing/Insourcing module 1026 may handle appropriate questions and answers related to the Outsourcing/Insourcing class as well as instructions for the user.

A Disposition module 1028 may be responsible for carrying out functions related to Disposition class cost savings. According to an embodiment of the invention. Disposition module 1028 may handle appropriate questions and answers related to the Disposition class as well as instructions for the user.

An Usage/Substitution module 1030 may be responsible for carrying out functions related to Usage/Substitution class cost savings. According to an embodiment of the invention. Usage/Substitution module 1030 may handle appropriate questions and answers related to the Usage/Substitution class as well as instructions for the user.

An Price/Leakage module 1032 may be responsible for carrying out functions related to Price/Leakage class cost savings. According to an embodiment of the invention. Price/Leakage module 1032 may handle appropriate questions and answers related to the Price/Leakage class as well as instructions for the user.

Data may be stored in a data storage module 1014. The data storage module 2036 stores a plurality of digital files. According to an embodiment of the invention, a plurality of data storage modules 1014 may be used and located on one or more data storage devices, where the data storage devices are combined or separate from the controller module 1012. One or more data storage modules 2036 may also be used to archive information.

While the system 1000 of FIG. 10 discloses the requester device 1005 connected to the network 1002, it should be understood that a personal digital assistant (“PDA”), a mobile telephone, a television, or another device that permits access to the network 1002 may be used to arrive at the system of the present invention. It is understood that, while system 1000 is represented in FIG. 10 as a network based system, other systems may also be used, with applicable modules resident therein. Other systems may also be used.

According to another embodiment of the invention, a computer-usable and writeable medium having a plurality of computer readable program code stored therein may be provided for practicing the process of the present invention. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system 2000 may comprise computer readable program code in the form of functional instructions stored in the computer-usable medium such that when the computer-usable medium is installed on the system 1000, those components cause the system 1000 to perform the functions described. The computer readable program code for the present invention may also be bundled with other computer readable program software.

According to one embodiment, the central controller module 1012, the transmitter module 1028, the receiver module 1018, the processor module 2016, and data storage module 1014, Plant and Equipment module 1022, Acquisition module 1024, Disposition, Module 1028. Outsourcing/Insourcing module 1026, Usage/Substitution module 1030 and Price/Leakage module 1032 may each comprise computer-readable code that, when installed on a computer, performs the functions described above. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

1. A process for calculating and attributing cost savings within an organization comprising the steps of:
determining whether a least a portion of the cost savings is attributable to a plant and equipment purchase;
calculating an amount of the plant and equipment cost savings;
determining whether a least a portion of the cost savings is attributable to an acquisition;
calculating an amount of the cost acquisition savings;
determining whether a least a portion of the cost savings is attributable to outsourcing or insourcing of a specified process;
calculating an amount of the outsourcing or insourcing cost savings;
determining whether a least a portion of the cost savings is attributable to a disposition;
calculating an amount of the disposition cost savings;
determining whether a least a portion of the cost savings is attributable to a usage substitution;
calculating an amount of the usage substitution cost savings;
determining whether a least a portion of the cost savings is attributable to a price or a leakage;
calculating an amount of the price or leakage cost savings;
determining whether at least a portion of the cost savings is attributable to a one time event;
calculating an amount of the one-time event cost savings; and
calculate the cost savings based upon the plant and equipment cost savings, the acquisition cost savings, the outsourcing or insourcing cost savings, the disposition cost savings, the usage substitution cost savings, the price or leakage cost savings, and the one-time expense cost savings.

2. The process according to claim 1, wherein the step of determining whether a least a portion of the cost savings is attributable to a plant and equipment purchase further comprises the steps of:
determining whether spending from the plant and equipment purchase is greater than a predetermined amount;
determining whether the portion of the cost savings was further attributable to a price reduction in the plant and equipment; and
attributing the cost savings to plant and equipment price leakage.

3. The process according to claim 1, wherein the step of determining whether a least a portion of the cost savings is attributable to an acquisition further comprises the steps of:
determining whether the cost savings was from a price reduction; and
attributing the cost savings to one of:
a) acquisition usage substitution; and
b) acquisition price leakage.

4. The process according to claim 1, where the step of determining whether a least a portion of the cost savings is attributable to an acquisition occurs when the cost savings occurs within a specified time period.

5. The process according to claim 1, where the step of determining whether a least a portion of the cost savings is attributable to outsourcing or insourcing of a specified process further comprises the steps of:
determining whether there was an increase in compensation and benefits; and
calculate the cost savings by one of:
a) calculating a net cost decrease in compensation and benefits with any increase in indirect purchase base spending; and
b) calculating a net cost increase in compensation and benefits with any decrease in indirect purchase base spending.

6. The process according to claim 1, where the step of determining whether a least a portion of the cost savings is attributable to outsourcing or insourcing of a specified process occurs when the cost savings occurs within a specified time period.

7. The process according to claim 1, where the step for determining whether a least a portion of the cost savings is attributable to a usage substitution further comprises the steps of:
determining whether the cost savings was the result of a business edict; and
attributing the cost savings to one of:
a) usage substitution; and
b) business productivity.

8. The process according to claim 1, where the step of determining whether a least a portion of the cost savings is attributable to a price or leakage further comprises the steps of:
determining whether the price was due to a change in the corporate contract; and
attributing the cost savings to one of:
a) price; and
b) leakage.

9. The process according to claim 1, where the steps of the process are performed using an digital spreadsheet.

10. A process calculating and attributing cost reductions using a decision matrix to facilitate consistent attribution comprises the steps of:
performing a plurality of determinations for attributing at least a portion of the cost reduction to at least one class;
calculating the class cost savings for each class to which a portion of the cost reduction has been attributed; and
calculating the total cost savings based on each of the class cost savings.

11. The process according to claim 10, wherein the steps of the process are performed using a digital spreadsheet.

12. A medium storing code for causing a processor to calculate and attribute cost savings within an organization, the medium comprising:
code for determining whether a least a portion of the cost savings is attributable to a plant and equipment purchase;
code for calculating an amount of the plant and equipment cost savings;
code for determining whether a least a portion of the cost savings is attributable to an acquisition;
code for calculating an amount of the cost acquisition savings;
code for determining whether a least a portion of the cost savings is attributable to outsourcing or insourcing of a specified process;
code for calculating an amount of the outsourcing or insourcing cost savings;
code for determining whether a least a portion of the cost savings is attributable to a disposition;
code for calculating an amount of the disposition cost savings;
code for determining whether a least a portion of the cost savings is attributable to a usage substitution;
code for calculating an amount of the usage substitution cost savings;
code for determining whether a least a portion of the cost savings is attributable to a price or a leakage;
code for calculating an amount of the price or leakage cost savings;
code for determining whether at least a portion of the cost savings is attributable to a one time event;
code for calculating an amount of the one-time event cost savings; and
code for calculate the cost savings based upon the plant and equipment cost savings, the acquisition cost savings, the outsourcing or insourcing cost savings, the disposition cost savings, the usage substitution cost savings, the price or leakage cost savings, and the one-time expense cost savings.

13. The medium according to claim 12, wherein the code for determining whether a least a portion of the cost savings is attributable to a plant and equipment purchase further comprises the steps of:
code for determining whether spending from the plant and equipment purchase is greater than a predetermined amount;
code for determining whether the portion of the cost savings was further attributable to a price reduction in the plant and equipment; and
code for attributing the cost savings to plant and equipment price leakage.

14. The medium according to claim 12, wherein the code for determining whether a least a portion of the cost savings is attributable to an acquisition further comprises the steps of:
code for determining whether the cost savings was from a price reduction; and
code for attributing the cost savings to one of:
a) acquisition usage substitution; and
b) acquisition price leakage.

15. The medium according to claim 12, where the code for determining whether a least a portion of the cost savings is attributable to an acquisition occurs when the cost savings occurs within a specified time period.

16. The medium according to claim 12, where code for determining whether a least a portion of the cost savings is attributable to outsourcing or insourcing of a specified process further comprises:
code for determining whether there was an increase in compensation and benefits; and
code for calculating the cost savings by one of:
a) calculating a net cost decrease in compensation and benefits with any increase in indirect purchase base spending; and
b) calculating a net cost increase in compensation and benefits with any decrease in indirect purchase base spending.

17. The medium according to claim 12, where the code for determining whether a least a portion of the cost savings is attributable to outsourcing or insourcing of a specified process occurs when the cost savings occurs within a specified time period.

18. The medium according to claim 12, where the code for determining whether a least a portion of the cost savings is attributable to a usage substitution further comprises the steps of:
code for determining whether the cost savings was the result of a business edict; and
code for attributing the cost savings to one of:
a) usage substitution; and
b) business productivity.

19. The medium according to claim 12, where the code for determining whether a least a portion of the cost savings is attributable to a price or leakage further comprises the steps of:
code for determining whether the price was due to a change in the corporate contract; and
code for attributing the cost savings to one of:
a) price; and
b) leakage.

20. The medium according to claim 12, where the code for the process are performed using an electronic spreadsheet.

21. A medium storing code for causing a processor to calculate and attribute cost reductions using a decision matrix to facilitate consistent attribution, where the medium comprises:
code for performing a plurality of determinations for attributing at least a portion of the cost reduction to at least one class;
code for calculating the class cost savings for each class to which a portion of the cost reduction has been attributed; and
code for calculating the total cost savings based on each of the class cost savings.

22. The medium according to claim 21, wherein the steps of the process are performed using a computer spreadsheet.

23. A system for calculating and attributing cost savings within an organization comprising:
means for determining whether a least a portion of the cost savings is attributable to a plant and equipment purchase;
means for calculating an amount of the plant and equipment cost savings;
means for determining whether a least a portion of the cost savings is attributable to an acquisition;
means for calculating an amount of the cost acquisition savings;
means for determining whether a least a portion of the cost savings is attributable to outsourcing or insourcing of a specified process;
means for calculating an amount of the outsourcing or insourcing cost savings;
means for determining whether a least a portion of the cost savings is attributable to a disposition;
means for calculating an amount of the disposition cost savings;
means for determining whether a least a portion of the cost savings is attributable to a usage substitution;
means for calculating an amount of the usage substitution cost savings;
means for determining whether a least a portion of the cost savings is attributable to a price or a leakage;
means for calculating an amount of the price or leakage cost savings;
means for determining whether at least a portion of the cost savings is attributable to a one time event;
means for calculating an amount of the one-time event cost savings; and
means for calculate the cost savings based upon the plant and equipment cost savings, the acquisition cost savings, the outsourcing or insourcing cost savings, the disposition cost savings, the usage substitution cost savings, the price or leakage cost savings, and the one-time expense cost savings.

24. The system according to claim 23, wherein the means for determining whether a least a portion of the cost savings is attributable to a plant and equipment purchase further comprises:
means for determining whether spending from the plant and equipment purchase is greater than a predetermined amount;
means for determining whether the portion of the cost savings was further attributable to a price reduction in the plant and equipment; and
means for attributing the cost savings to plant and equipment price leakage.

25. The system according to claim 23, wherein the means for determining whether a least a portion of the cost savings is attributable to an acquisition further comprises:
means for determining whether the cost savings was from a price reduction; and
means for attributing the cost savings to one of:
a) acquisition usage substitution; and
b) acquisition price leakage.

26. The system according to claim 23, where the means for determining whether a least a portion of the cost savings is attributable to an acquisition occurs when the cost savings occurs within a specified time period.

27. The system according to claim 23, where the means for determining whether a least a portion of the cost savings is attributable to outsourcing or insourcing of a specified process further comprises:
means for determining whether there was an increase in compensation and benefits; and
means for calculate the cost savings by one of:
a) calculating a net cost decrease in compensation and benefits with any increase in indirect purchase base spending; and
b) calculating a net cost increase in compensation and benefits with any decrease in indirect purchase base spending.

28. The system according to claim 23, where the means for determining whether a least a portion of the cost savings is attributable to outsourcing or insourcing of a specified process occurs when the cost savings occurs within a specified time period.

29. The system according to claim 23, where the means for determining whether a least a portion of the cost savings is attributable to a usage substitution further comprises:
means for determining whether the cost savings was the result of a business edict; and
means for attributing the cost savings to one of:
a) usage substitution; and
b) business productivity.

30. The system according to claim 23, where the means for determining whether a least a portion of the cost savings is attributable to a price or leakage further comprises:
means for determining whether the price was due to a change in the corporate contract; and
means for attributing the cost savings to one of:
a) price; and
b) leakage.

31. The system according to claim 23, where the system includes the use of an digital spreadsheet.

32. A system calculating and attributing cost reductions using a decision matrix to facilitate consistent attribution comprises:
means for performing a plurality of determinations for attributing at least a portion of the cost reduction to at least one class;
means for calculating the class cost savings for each class to which a portion of the cost reduction has been attributed; and
means for calculating the total cost savings based on each of the class cost savings.

33. The system according to claim 32, wherein the system includes the use of an digital spreadsheet.

34. A system for calculating and attributing cost savings within an organization comprising:
a module for determining whether a least a portion of the cost savings is attributable to a plant and equipment purchase;
a module for calculating an amount of the plant and equipment cost savings;
a module for determining whether a least a portion of the cost savings is attributable to an acquisition;
a module for calculating an amount of the cost acquisition savings;
a module for determining whether a least a portion of the cost savings is attributable to outsourcing or insourcing of a specified process;
a module for calculating an amount of the outsourcing or insourcing cost savings;
a module for determining whether a least a portion of the cost savings is attributable to a disposition;
a module for calculating an amount of the disposition cost savings;
a module for determining whether a least a portion of the cost savings is attributable to a usage substitution;
a module for calculating an amount of the usage substitution cost savings;
a module for determining whether a least a portion of the cost savings is attributable to a price or a leakage;
a module for calculating an amount of the price or leakage cost savings;
a module for determining whether at least a portion of the cost savings is attributable to a one time event;
a module for calculating an amount of the one-time event cost savings; and
a module for calculate the cost savings based upon the plant and equipment cost savings, the acquisition cost savings, the outsourcing or insourcing cost savings, the disposition cost savings, the usage substitution cost savings, the price or leakage cost savings, and the one-time expense cost savings.

35. The system according to claim 34, wherein the module for determining whether a least a portion of the cost savings is attributable to a plant and equipment purchase further comprises:
a module for determining whether spending from the plant and equipment purchase is greater than a predetermined amount;
a module for determining whether the portion of the cost savings was further attributable to a price reduction in the plant and equipment; and
a module for attributing the cost savings to plant and equipment price leakage.

36. The system according to claim 34, wherein the module for determining whether a least a portion of the cost savings is attributable to an acquisition further comprises:
a module for determining whether the cost savings was from a price reduction; and
a module for attributing the cost savings to one of:
a) acquisition usage substitution; and
b) acquisition price leakage.

37. The system according to claim 34, where the module for determining whether a least a portion of the cost savings is attributable to an acquisition occurs when the cost savings occurs within a specified time period.

38. The system according to claim 34, where the module for determining whether a least a portion of the cost savings is attributable to outsourcing or insourcing of a specified process further comprises:
a module for determining whether there was an increase in compensation and benefits; and
a module for calculate the cost savings by one of:
a) calculating a net cost decrease in compensation and benefits with any increase in indirect purchase base spending; and
b) calculating a net cost increase in compensation and benefits with any decrease in indirect purchase base spending.

39. The system according to claim 34, where the module for determining whether a least a portion of the cost savings is attributable to outsourcing or insourcing of a specified process occurs when the cost savings occurs within a specified time period.

40. The system according to claim 34, where the module for determining whether a least a portion of the cost savings is attributable to a usage substitution further comprises:
a module for determining whether the cost savings was the result of a business edict; and
a module for attributing the cost savings to one of:
a) usage substitution; and
b) business productivity.

41. The system according to claim 34, where the module for determining whether a least a portion of the cost savings is attributable to a price or leakage further comprises:
a module for determining whether the price was due to a change in the corporate contract; and
a module for attributing the cost savings to one of:
a) price; and
b) leakage.

42. The system according to claim 35, where the system uses a digital spreadsheet.

43. A system for calculating and attributing cost reductions using a decision matrix to facilitate consistent attribution, where the system comprises:
a module for performing a plurality of determinations for attributing at least a portion of the cost reduction to at least one class;
a module for calculating the class cost savings for each class to which a portion of the cost reduction has been attributed; and
a module for calculating the total cost savings based on each of the class cost savings.

44. The system according to claim 43, wherein the system used a digital spreadsheet.
